(19) United States
(12) Patent Application Publication
(10) Pub. No.: US 2023/0047406 A1
(43) Pub. Date: Feb. 16, 2023

(54) Kitchen Storage System with Stackable Canisters

(71) Applicant: Natthawat Kityanyong, North Ryde (AU)

(72) Inventor: Natthawat Kityanyong, North Ryde (AU)

(21) Appl. No.: 17/670,587

(22) Filed: Feb. 14, 2022

Related U.S. Application Data
(60) Provisional application No. 63/232,692, filed on Aug. 13, 2021.

(51) Int. Cl. B65D 21/02

(52) U.S. Cl. CPC B65D 21/0231; B65D 21/0223; B65D 21/0228

(57) ABSTRACT

Provided a kitchen storage system with stackable canisters comprises a plurality of canisters that further includes a lid. The lid has an attachment mechanism that is altogether hidden and embedded inside the lid and a lid handle, allowing each canister's lid handle to fit on top. Each of the plurality of canisters also includes a base detachably connected to side walls, the base including a hole to allow for the lid handle attached to the lid of each of the canisters below, to fit inside the hole, when the hole and the lid handle are aligned, each of the canisters being placed flat on top of the lid, the lid handle acts as a stopper to prevent each of the canisters above from sliding, moving, or falling off when force is being exerted by a user or when the canisters are being placed on an uneven surface.

### CROSS-REFERENCE TO RELATED APPLICATION

This disclosure claims the benefit of the priority of U.S. Provisional Patent Application No. 63/232,692, entitled “Kitchen Storage Device” and filed on Aug. 13, 2021. The above-identified application is incorporated herein by reference in its entirety.

### BACKGROUND

### Field of Invention

The present invention relates to storage system, and more particularly, the present invention relates to a kitchen storage system with a plurality of different sized stackable canisters.

### Description of Related Art

Consumers may store and organise their stuff with the help of a variety of organisers, storage items and systems. Consumers, on the other hand, are constantly accumulating goods and/or moving items from one spot in their home to another. Handling and storing stacks of similar items like containers, dishes, and bowls presents a number of challenges that have been addressed in a variety of methods.

Many containers are designed to stack or interlock with one another. Many plastic food containers, for example, are built so that the top and bottom of each container, as well as each container or lid, are aligned to facilitate interlocking container stacking. Most of the traditional kitchen storage canisters keep items inside with a lid on top, but they do not allow canisters to stack on top of one another. Further, traditional canisters take up more storage space. When force is applied to a stacked canister, there is no practical means to prevent the canister above from falling on the canister below. There is currently no way for the canisters to stack on top of one another and firmly self-lock in place.

For example, prior art detailed in US patent U.S. Pat. No. 8,201,699B2 fails to prevent the canisters above from sliding, shifting, or falling off when a user exerts force or when the canisters are placed on an uneven surface.

As a result, a kitchen storage system with stackable canisters is required, one that allows for nestable storage of boxes in a simple and space-saving manner while also allowing the containers to be stacked on their sides.

The references to and descriptions of past plans or products made above are not intended to be, and should not be interpreted as, claims or confessions of widespread general knowledge in the art. The preceding prior art discussion, in particular, does not pertain to what is frequently or well known by a person versed in the art, but rather aids in the comprehension of the inventive step of the present invention, of which the identification of appropriate previous art proposals is just one element.

### SUMMARY

The present invention aims to make it feasible for kitchen storage system to be securely stacked on top of each other when a user exerts force or when stacked canisters are put on an uneven surface.

Another objective of the present invention is to provide a solution for more efficient and space-saving storage by allowing canisters to be stacked on top of one another.

Embodiments in accordance with the present invention provides a kitchen storage system with stackable canisters. The system comprises a plurality of canisters used in kitchens for space-saving storage arrangements. The plurality of canisters is stacked on top of one another and fit inside storage spaces. Each of the plurality of canisters includes a lid of a predefined shape for each of the canisters, providing coverage and support for the next stackable canister. Further, the lid has an attachment mechanism that is altogether hidden and embedded inside the lid and a lid handle, allowing each canister's lid handle to fit on top. Each of the plurality of canisters also includes a base detachably connected to side walls, the base includes a hole to allow for the lid handle attached to the lid of each of the canisters below, to fit inside the hole, when the hole and the lid handle are aligned, each of the canisters being placed flat on top of the lid, the lid handle acts as a stopper to prevent each of the canisters above from sliding, moving around, or falling off when force is being exerted by a user or when the canisters are being placed on an uneven surface.

In one embodiment of the present invention, a screw buried within the lid serves as the attachment mechanism.

In one embodiment of the present invention, the plurality of canisters may comprise apertures for air passage. In preferred embodiments of the present invention, the plurality of canisters may comprise apertures or aerating holes for air passage at equal spacing all around. In one of the preferred embodiments, the apertures or aerating holes for air passage are at upper portion of side wall. In the embodiment, there may be a magnetic sheet that can slide to block the apertures or aerating holes to achieve airtight canisters.

In one embodiment of the present invention, the plurality of canisters may be of variable sizes and shapes to be stacked into one another.

In one embodiment of the present invention, the predefined shape of the lid comprises a flat lid, a lid with raised edges all around, a lid with groove all around and/or any foregoing combination.

Embodiments in accordance with the present invention provides a plurality of stackable canisters used in kitchens for space-saving storage arrangements. The plurality of canisters is stacked on top of one another and fit inside storage spaces when empty, each of the plurality of stackable canisters comprises an ergonomic lid for each of the stacked canisters that provides coverage and support for the next stackable canister. Each of the ergonomic lids has a size dependent on the size of the base with side walls, each of the ergonomic lid features a screw that is entirely hidden and incorporated into the lid that provides flat surface to stack the canister's lid at one another. Each of the plurality of stackable canisters includes the base associated with side walls, including a hole to allow for the lid handle attached to the lid of each of the canisters below, to fit inside the hole, when the hole and the lid handle are aligned, each of the canisters being placed flat on top of the ergonomic lid, the ergonomic lid handle serves as a stopper to prevent each of the canisters above from sliding, moving around, or falling off when force is being exerted by a user or when the canisters are being placed on an uneven surface.

Embodiments in accordance with the present invention provide a process for making a kitchen storage system with stackable canister. The process includes stacking a plurality of canisters used in kitchens for space-saving storage arrangements, the plurality of canisters is stacked on top of one another and fit inside storage spaces. The process also includes providing coverage and support for the next stackable canister using a lid for each of the canisters. The process also includes embedding an attachment mechanism that is altogether hidden and embedded inside the lid and a lid handle, allowing each canister's lid handle to fit on top. The process also includes connecting a base detachably to side walls to obtain a canister, the base including a hole to allow for the lid handle attached to the lid of each of the canisters below, to fit inside the hole, when the hole and the lid handle are aligned, each of the canisters being placed flat on top of the lid, the lid handle acts as a stopper to prevent each of the canisters above from sliding, moving around, or falling off when force is being exerted by a user or when the canisters are being placed on an uneven surface.

In one embodiment of the present invention, the base of the canisters is a raised platform that fits into the detachable side walls of the canister.

In one embodiment of the present invention, the lid handle is cylindrical, isosceles trapezium from the top, but bent from the edges, circular, rectangular, or any combination of these shapes. In the embodiment the hole may be cylindrical, isosceles trapezium, circular, rectangular, or any combination of these shapes.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A-1C illustrates a perspective view of plurality of canisters of the kitchen storage system with stackable canisters, according to embodiments of the present invention disclosed herein;

FIG. 2A illustrates a perspective view of a kitchen storage system with stackable canisters, according to embodiments of the present invention disclosed herein;

FIG. 2B illustrates a bottom view of a lid of the kitchen storage system with stackable canisters, according to embodiments of the present invention disclosed herein;

FIG. 2C illustrates a top view of the lid of the kitchen storage system with stackable canisters, according to embodiments of the present invention disclosed herein;

FIG. 2D illustrates a top view of the lid of the kitchen storage system with stackable canisters having a region surrounding a lid handle, according to embodiments of the present invention disclosed herein;

FIG. 2E illustrates a cross sectional view of the lid of the kitchen storage system with stackable canisters having a region surrounding a lid handle, according to embodiments of the present invention disclosed herein;

FIG. 3A illustrates a top view of one of the plurality of canisters showing protruding side of an isosceles trapezium hole type, according to embodiments of the present invention disclosed herein;

FIG. 3B illustrates a bottom view of one of the plurality of canisters showing an isosceles trapezium hole type, according to embodiments of the present invention disclosed herein;

FIG. 3C illustrates a sectional view of an isosceles trapezium hole type of one of the plurality of canisters according to embodiments of the present invention disclosed herein;

FIG. 4A illustrates a sectional view of a cylindrical hole type of one of the plurality of canisters according to embodiments of the present invention disclosed herein;

FIG. 4B illustrates a top view one of the plurality of canisters showing protruding side of a cylindrical hole type, according to embodiments of the present invention disclosed herein;

FIG. 4C illustrates a sectional view of an “upside-down cup” of one of the plurality of canisters, according to embodiments of the present invention disclosed herein;

FIG. 5A illustrates a sectional view of the plurality of canisters stacked on top on one another with a flat shape lid, according to embodiments of the present invention disclosed herein;

FIG. 5B illustrates a sectional view of the plurality of canisters stacked inside each other, according to embodiments of the present invention disclosed herein;

FIG. 5C illustrates an expanded view of the hole and lid handle arrangement of the kitchen storage system with stackable canisters with a flat lid, according to embodiments of the present invention disclosed herein;

FIG. 5D illustrates an enlarged view of the hole and lid handle arrangement of the kitchen storage system with stackable canisters having lid with raised edge all around, according to embodiments of the present invention disclosed herein;

FIG. 5E illustrates an enlarged view of the hole and lid handle arrangement of the kitchen storage system with stackable canisters having lid with groove all around, according to embodiments of the present invention disclosed herein;

FIG. 6A illustrates a sectional view of the plurality of canisters stacked inside of the kitchen storage system with stackable canisters when empty having cylindrical hole type and flat base, according to embodiments of the present invention disclosed herein;

FIG. 6B illustrates a sectional view of the plurality of canisters stacked inside of the kitchen storage system with stackable canisters when empty having isosceles trapezium hole type and flat base, according to embodiments of the present invention disclosed herein;

FIG. 7A-7B illustrates variant perspective view of the plurality of canisters stacked inside when empty having cylindrical hole type in the base in according to embodiments of the present invention disclosed herein;

FIG. 8A illustrates a cross-sectional view of a packaging box of a plurality of canisters stacked inside of the kitchen storage system with stackable canisters, according to embodiments of the present invention disclosed herein

FIG. 8B illustrates a top view of a packaging box a plurality of canisters stacked inside of the kitchen storage system with stackable canisters, according to embodiments of the present invention disclosed herein;

FIG. 9A, 9B, 9C, 9D, 9E illustrates prospective view of rectangular canister with rounded ends in according to embodiments of the present invention disclosed herein; and

FIG. 10 illustrates a flowchart of a process for making the kitchen storage system with stackable canisters, according to embodiments of the present invention disclosed herein.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The following description includes the preferred best mode of one embodiment of the present invention. It will be clear from this description of the invention that the invention is not limited to these illustrated embodiments, but the invention also includes a variety of modifications and embodiments. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

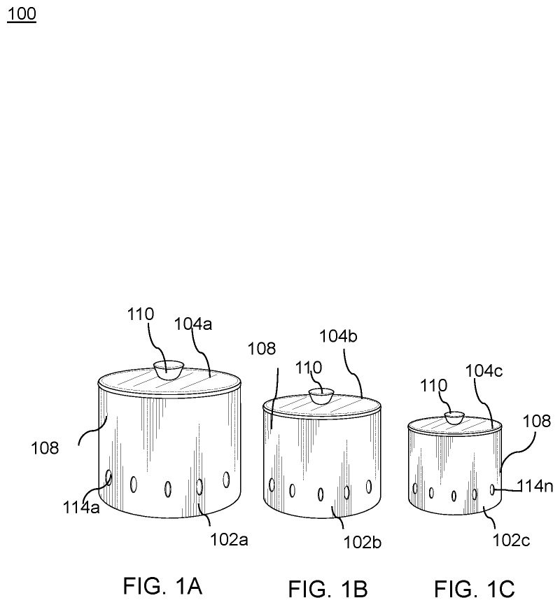

FIG. 1A-1C illustrates a perspective view of plurality of canisters 102 of the kitchen storage system with stackable canisters 100, according to embodiments of the present invention. The system 100 comprises a plurality of canisters 102a-102c (hereinafter referred to as the canisters 102), a plurality of lids 104a-104d (hereinafter referred to as the lids 104), a base 106, side walls 108, a lid handle 110, an handle screw 112, apertures 114a-114n (hereinafter referred to as the apertures 114), a hole 116 having protruding side 116a, the hole may be of various shape including cylindrical, isosceles, according to embodiments of the present invention.

The plurality of canisters 102 may be used in kitchens for space-saving storage arrangements. The plurality of canisters 102 may comprise variant sizes and shapes. FIG. 1A depicts a first canister 102a as the largest, FIG. 1B depicts a second canister 102b as the smaller, and FIG. 1C depicts a third canister 102c as the smallest. Each of the canisters 102 has a lid 104 that fits over it and is identical in size to the canister 102. In the embodiment, there may be a plurality of canisters of different size and shape.

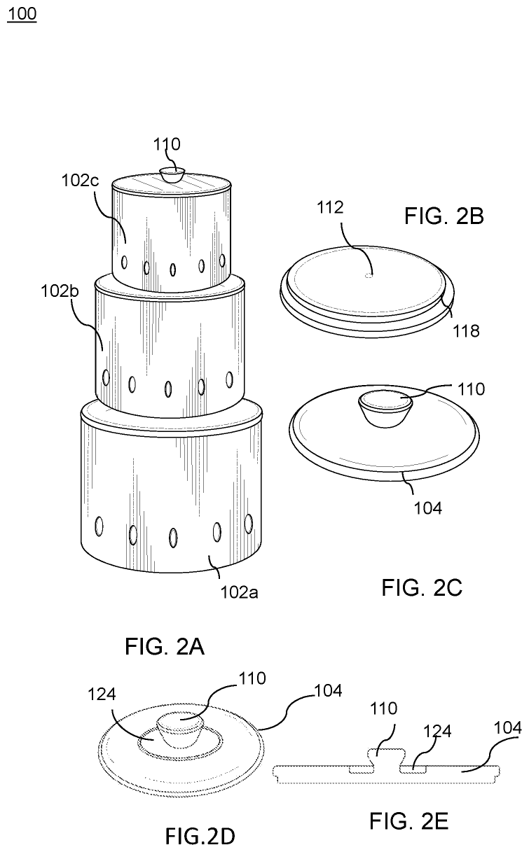

FIG. 2A illustrates a perspective view of a kitchen storage system with stackable canisters 100, according to embodiments of the present invention. The canisters 102 may be stacked on top of one another vertically. The plurality of canisters 102 may comprise variant sizes and shapes stacked on the top another vertically.

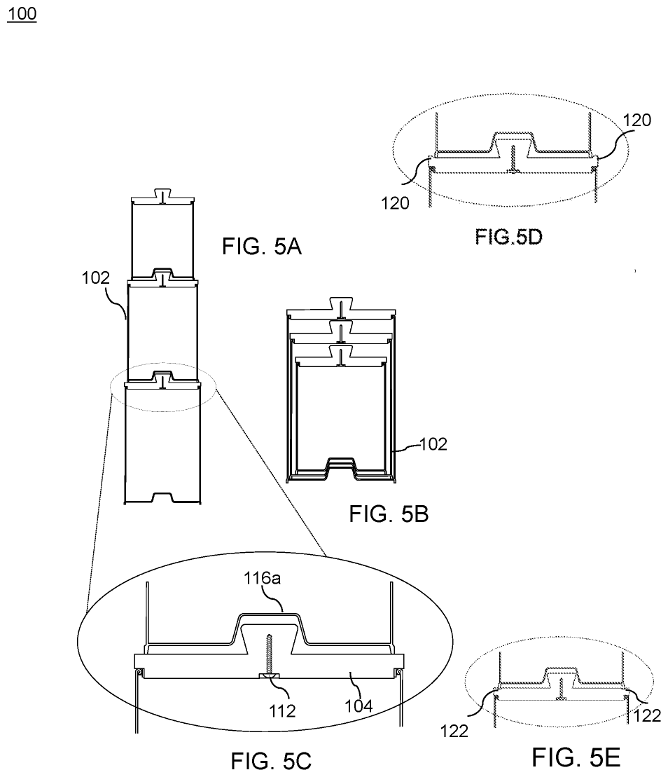

FIG. 2B illustrates a bottom view of the lid 104 of the kitchen storage system with stackable canisters 100, according to embodiments of the present invention. According to embodiments of the present invention, the lid 104 of a predefined shape for each of the canisters 102 may provide coverage and support for the next stackable canister 102. In one embodiment of the present invention, the predefined shape of the lid 104 comprises a flat shape lid as seen in FIG. 5A, a lid 104 with raised edge all around the lid 104 as seen in FIG. 5D, a lid 104 with groove 122 all around the lid 104 as seen in FIG. 5E, and/or any foregoing combination.

The lid 104 may have a handle screw 112 that is altogether hidden and embedded inside the lid 104 and the lid handle 110, allowing each canister's lid handle 110 to fit on top. The lid 104 may comprise a fold up 118 to fit into the top of the canister 102 for closure, as seen particularly in FIG. 2B.

FIG. 2C illustrates a top view of the lid of the kitchen storage system with stackable canisters 100, according to embodiments of the present invention. FIG. 2C shows the lid handle 110 attached to the top of the lid 104 for lifting the lid 104 of the stackable canister 102 easily. FIG. 2D illustrates a top view of the lid 104 of the kitchen storage system 100 with stackable canisters having a region 124 surrounding a lid handle 110, according to embodiments of the present invention. In the embodiment the region 124 may be deep well around the lid handle 110. The region 124 may be on a lower level than the lid 104 itself. Further, FIG. 2E illustrates a cross sectional view of the lid 104 of the kitchen storage system 100 with stackable canisters 102 having the region 124 surrounding the lid handle 110.

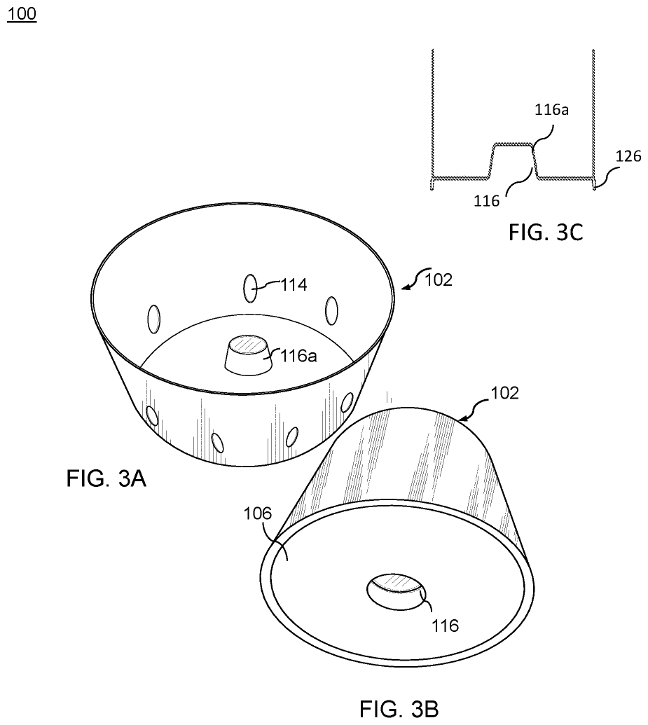

Referring to FIG. 3A illustrating a top view of one of the plurality of canisters 102, according to embodiments of the present invention. Any solid items, liquid products, ultrafine products, or any mix of the aforementioned may be stored in the plurality of canisters 102. The solid items may comprise vegetables such as potatoes, onions, garlic, other solid products such as coffee, sugar, powder, flour, rice, beans, bread and so forth. According to embodiments of the present invention, the plurality of canisters 102 may be made of a material such as, but not limited to, galvanized steel, plastic, aluminium, any metal, or any other material. In one of the preferred embodiments of the present, the plurality of canisters 102 may be made of galvanized steel that may be 0.3 mm thick. In FIG. 3A, the protruding side 116a is clearly visible due to the development of a hole 116 in the base 106, as shown in FIG. 3B. The hole 116 may be of various shape and size that may include isosceles trapezium from the top as seen in 3A, cylindrical (4A, 4B, 4C), circular, rectangular, or any combination of these shapes. In the embodiment in reference to FIG. 3C, the base 106 may have a base edge 126 for supporting the placement of canister 102 on a surface. In an embodiment of the presen invention, the base edge 126 may fit into the groove 122 to prevent chances of slippage during stacking of canisters one above the other.

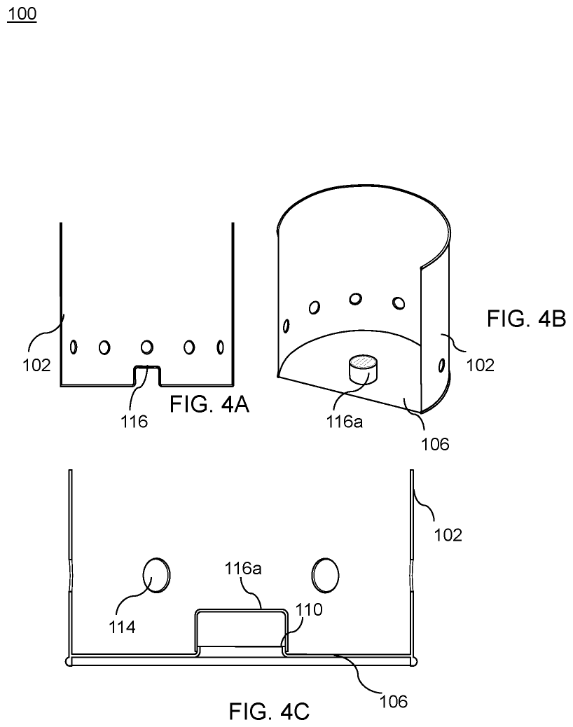

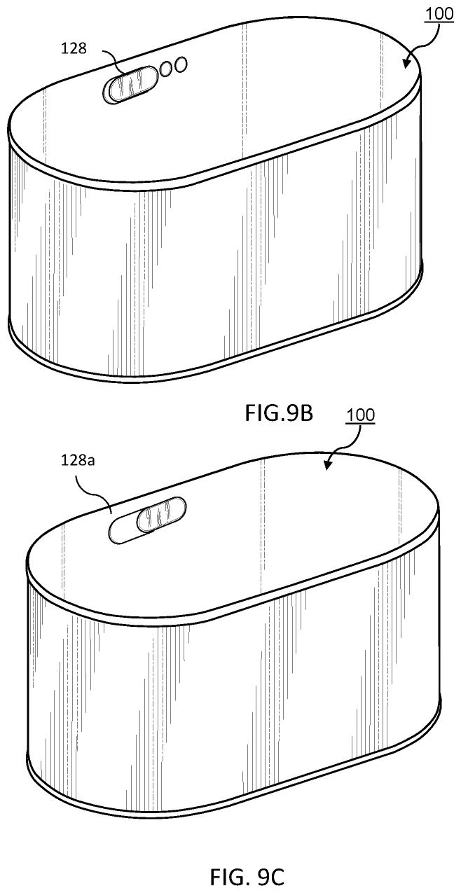

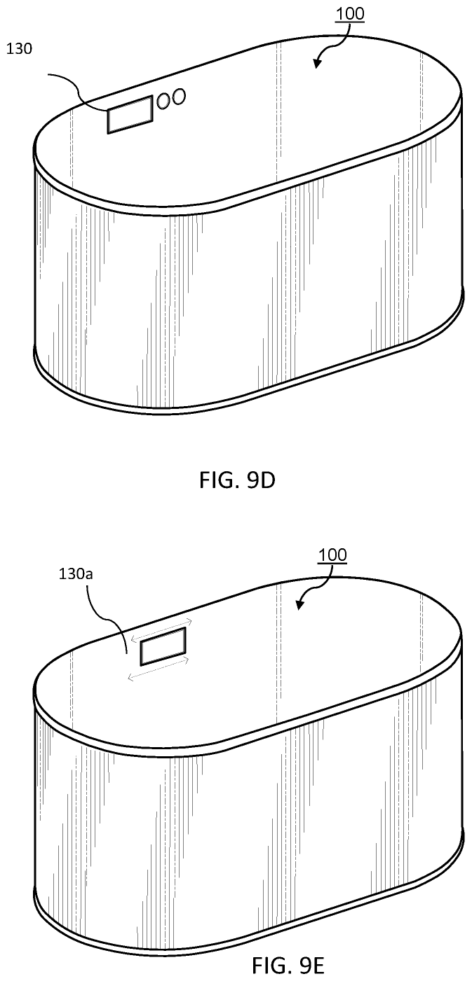

In an embodiment of the present invention, the lid handle 110 may have a size that may range between 25 mm to 40 mm. The lid handle 110 may have a height that ranges from 10 mm to 20 mm. Furthermore, the plurality of canisters 102 may comprise apertures 114 for air passage, as seen in FIGS. 4A, 4B, 4C, 9D and 9E. In reference to FIG. 9A to 9E the apertures 114 or aerating holes may be optional at upper portion of the canister wall. In preferred embodiments in reference to FIG. 9A-9C, apertures 114 or aerating holes may be closed by slidable magnetic sheet 128 to make the canister airtight or opened to get air ventilation to avoid build up moistures. In one of the preferred embodiments in reference to FIG. 9D-9E, apertures 114 or aerating holes may be closed by magnetic sheet 130 by simply moving to the holes to make the canister airtight or opened to get air ventilation to avoid build up moistures. The lid handle 110 may act as a stopper to prevent each of the canisters 102 above from sliding, moving around, or falling off when force is being exerted by a user or when the canisters 102 are being placed on an uneven surface.

In one of the preferred embodiments of the present invention referring to FIGS. 4A, 4B and 4C, the hole 116 being a mold is generated during the manufacturing process to produce a standard “upside-down cup”, as seen in FIG. 4C. Each of the upside-down cups is then connected to the canister 102 to cover the gap at the base 106 of each of the canisters 102 while still allowing enough space for the lid handle 110 to fit inside.

In an embodiment of the present invention, the base 106 may have a fold up 118 that fits into the canister's detachably attached side walls 102.

In reference to FIG. 5A, FIG. 5A shows a sectional view of the plurality of canisters 102 stacked on top of one another with a flat shape lid, according to embodiments of the present invention. At least two canisters 102 may be stacked over one another for saving space. In another embodiment of the present invention, utensils with the hole 116 to fit the lid handle 110 of the canister 102 may be stacked upon that canister 102. In another embodiment of the present invention, the lid 104 and the lid handle 110 may be made in two pieces separately.

FIG. 5B illustrates a sectional view of the plurality of canisters 102 stacked inside each other. Even with the lid 104 intact, at least two canisters 102 may be stacked inside each. FIG. 5C illustrates an expanded view of the hole 116 and lid handle 110 arrangement of the kitchen storage system 100 with stackable canisters with the flat lid 104. The canister's edged base 106 may be fitted over the flat lid 104 of the immediate canister 102. Referring to FIG. 5D, an enlarged view of the hole 116 and lid handle 110 arrangement of the kitchen storage system 100 with stackable canisters having lid with raised edge 120 all around is shown, which prevents the moving or sliding of the stacked canisters 102. Referring to FIG. 5C, according to embodiments of the present invention, a screw may be buried within the lid 104 serves as the attachment mechanism 112. Referring to FIGS. 5D and 5E, according to preferred embodiments of the present invention, the lid 104 may comprise a bamboo lid with a groove 122 or an indent all around on the top surface of the lid 104. Further, the bamboo lid may have a raised edge 120 all around to stop the canister 102 from falling. In an embodiment of the present invention, the thickness of the bamboo lid may range between 10 mm to 20 mm. In one embodiment of the present invention, the lid 104 may have a raised edge 120 that prevents the immediate stacked up canister 102 from falling, as seen in FIG. 5D. The base 106 of each of the canisters 102 and the “trapezium hole type” is made from one piece of steelwork to reduce the amount of welding in joining the canister's base 106 and “upside-down cup together. At least one of the plurality of canisters 102 may comprise dividers, recipe cards, or any combination. The raised edge 120 located all around the lid 104 may be used to prevent the canister 102 from falling or sliding. In one of the embodiments of the present invention, the volume weight of the system 100 may be 2.4 kg. The product weight may be 2 kg.

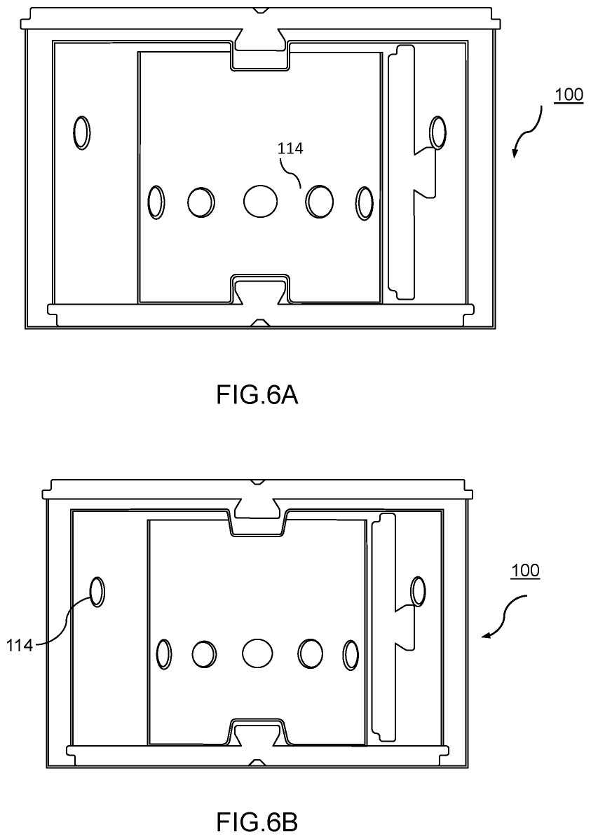

FIG. 5E illustrates an enlarged view of the hole 116 and lid handle 110 arrangement of the kitchen storage system 100 with stackable canisters 102 having lid 104 with groove 122 all around the lid. The end of the lid 104 with groove 122 all-round may be raised to prevent slipping or falling of the canisters 102. To keep the stackable canisters 102 from dropping or sliding, the edged base 106 of the canister 102 may be inserted into the groove 122 of the lid 104. FIG. 6A illustrates a sectional view of the plurality of canisters 102 stacked inside of the kitchen storage system 100 with stackable canisters when empty, with an edge all around the base 102. The hole 116 present in base 106 is a one-sided open circle. Further, FIG. 6B depicts a sectional view of the plurality of canisters 102 stacked inside of the kitchen storage system 100 with stackable canisters when empty, with flat base 106. The base 106 has the hole 116 shaped as the isosceles trapezium at 60 to 80 degrees. In the embodiment in reference to FIG. 6A, 6B, a plurality of canisters with cylindrical and isosceles trapezium hole type is illustrated to show that canisters may be placed inside with flat base arrangement where lid may be placed at bottom, side and top position.

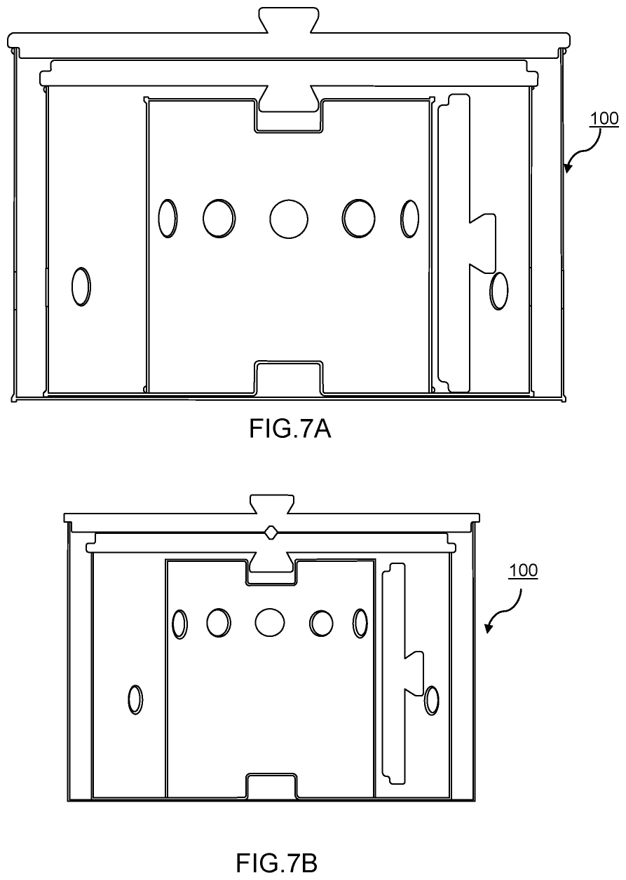

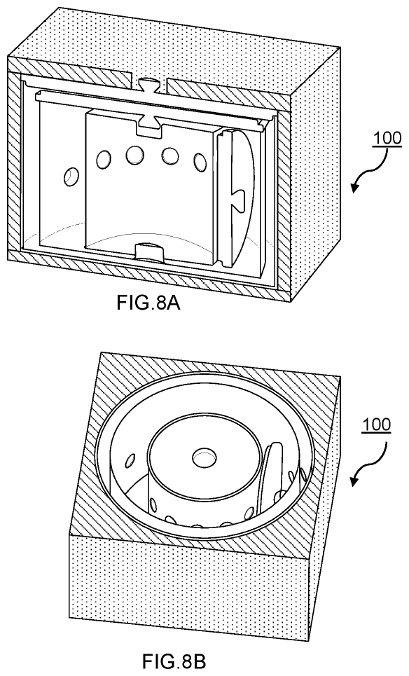

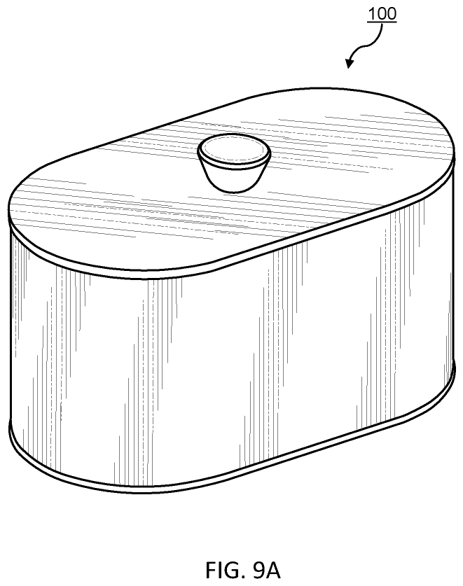

FIGS. 7A, 7B, 8A and 8B illustrates various view of the plurality of canisters 102 stacked inside, according to embodiments of the present invention. The lids 104 of each are positioned opposite each other, vertically, horizontally, or in any other position. In an embodiment of the present invention, the height of the kitchen storage system with stackable canisters 100 may be less than 203 mm when placed in a packaging container. The height of the kitchen storage system with stackable canisters 100 may be varied with the lid 104/without lid 104.

In an embodiment of the present invention, the base 106 may be detachably connected to side walls 108. The base 106 may comprise the hole 116 to allow for the lid handle 110 attached to the lid 104 of each of the canisters 102 below, to fit inside the hole 116. In one embodiment of the present invention, the protruding side 116a of the hole 116 of one of the canisters 102 formed due to development of the hole 116 may be inserted into the hole 116 of the immediate canister 102. When the hole 116 and the lid handle 110 are aligned, each of the canisters 102 being placed flat on top of the lid 104. In the embodiment in reference to FIG. 7A, 7B, a plurality of canisters with cylindrical hole type is illustrated arrangement of canisters 102 and lids 104 in accordance with the invention.

In another preferred embodiment of the present invention, an intent of the upside-down cup is to be used as a cover to protect the lid handle 110 from coming into contact with the vegetables or goods, as well as prevent fluid from leaking out through the gap.

The hole 116 is also formed in any of the following ways: cylindrical, isosceles trapezium at 60 to 80 degrees, rectangular, square, circular, so forth. Embodiments of the present invention are intended to include or otherwise cover any type of the shape of the hole 116, including known, related art, and/or later developed technologies. In an embodiment of the present invention, the plurality of canisters 102 may be powder coated. The hole 116 may have a height of 10 mm to 20 mm, a top with a distance of 25 mm to 40 mm, a bottom with a distance of 35 mm to 50 mm.

In preferred embodiments of the present invention, the bottom canister 102a may comprise a flat base with or without any hole 116. The hole 116 and lid handle 110 coupling comprise any kind of magnetic property to provide more strength to the stack of the plurality of canisters 102.

Referring to FIG. 7A to 8B, the plurality of stackable canisters 102 may be used in kitchens for space-saving storage arrangements. The plurality of canisters 102 may be stacked and fit inside storage spaces when empty. Each of the plurality of stackable canisters 102 may comprise an ergonomic lid 104 for each of the stacked canisters 104 that provides coverage and support for the next stackable canister 104, each of the ergonomic lids 104 has a size dependent on the size of the base 106 with side walls 108.

Each of the ergonomic lids 104 features a screw 112 that is entirely hidden and incorporated into the lid 104, as well as a lid handle 110 that allows each canister's lid handle 110 to fit on top.

The base 106 with side walls 108, including the hole 116 to allow for the lid handle 110 attached to the lid 104 of each of the canisters 102 below, to fit inside the hole 116, when the hole 116 and the lid handle 110 are aligned, each of the canisters 102 being placed flat on top of the ergonomic lid 104, the ergonomic lid handle 110 serves as a stopper to prevent each of the canisters 104 above from sliding, moving around, or falling off when force is being exerted by a user or when the canisters 104 are being placed on an uneven surface.

In reference to FIG. 9A to 9E the apertures 114 or aerating holes may be optionally provided on the upper portion of the canister wall based on usage of the canisters such as bread box. In preferred embodiments of the invention in reference to FIG. 9A-9C, apertures 114 or aerating holes may be closed by slidable sheet 128 to make the canister airtight or opened to get air ventilation to avoid build up moistures. In the preferred embodiment, the slidable sheet may be made of plastics, wood, magnetic material or any other suitable material based on the make of the canisters. Further the sheets may be of any shape or size suitable to close the holes and facilitate movement of the sheet. In one of the preferred embodiments in reference to FIG. 9D-9E, where the canisters are made of metal such as magnetic materials, apertures 114 or aerating holes may be closed by magnetic sheet 130 by simply moving to the holes to make the canister 102 airtight or opened to get air ventilation to avoid build up moistures. The magnetic material may of any shape and size preferably rectangular shape. In the embodiment, FIG. 9B shows a slidable sheet 128 when the slidable sheet 128 is away from the apertures 114 or aerating holes and FIG. 9C illustrates the position of the slidable sheet 128a to close the apertures 114. In the other embodiment, FIG. 9D shows a magnetic sheet 130 when a magnetic sheet 130 is away from the apertures 114 or aerating holes and FIG. 9E illustrates the position of the magnetic sheet 130a which can move to any position manually over the metallic wall of the canisters due to magnetic field to close the apertures 114. In the embodiment, the canisters body may be made of ferromagnetic material.

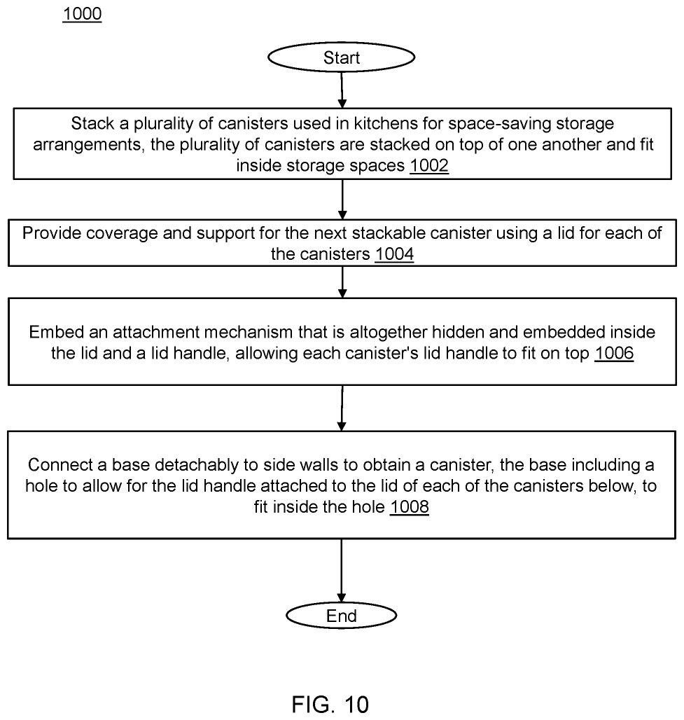

FIG. 10 illustrates a flowchart of a process 1000 for making a kitchen storage system with stackable canister 100, according to embodiments of the present invention.

At 1002, the plurality of canisters 102 used in kitchens that may be stacked for space-saving storage arrangements, the plurality of canisters 102 are stacked on top of one another and fit inside storage spaces.

At 1004, providing coverage and support for the next stackable canister 102 using the lid 104 for each of the canisters 102.

At 1006, embedding the attachment mechanism 112 that is altogether hidden and embedded inside the lid 104 and the lid handle 110, allowing each canister's lid handle 110 to fit on top.

At 1008, the base 106 may be connected detachably to side walls 108 to obtain the canister 102. The hole 116 allows the lid handle 110 of the lid 104 to accommodate inside. The lid handle 110 fits inside the hole 116, when the hole 116 and the lid handle 110 are aligned, each of the canisters 102 is placed on top of the lid 104, the lid handle 110 acts as a stopper to prevent each of the canisters 102 above from sliding, moving around, or falling off when force is being exerted by a user or when the canisters 102 are being placed on an uneven surface. The base 106 may have the fold up 118 that fits into the detachable side walls 108 of the canister 102.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

What is claimed:

1. A kitchen storage system with stackable canisters, the system comprising:
a plurality of canisters used in kitchens for space-saving storage arrangements, the plurality of canisters is stacked on top of one another and fit inside storage spaces, each of the plurality of canisters includes:
a lid of a predefined shape for each of the canisters, providing coverage and support for the next stackable canister, the lid has an attachment mechanism that is altogether hidden and embedded inside the lid and a lid handle, allowing each canister's lid handle to fit on top; and
a base detachably connected to side walls, the base including a hole to allow for the lid handle attached to the lid of each of the canisters below, to fit inside the hole, when the hole and the lid handle are aligned, each of the canisters being placed flat on top of the lid, the lid handle acts as a stopper to prevent each of the canisters above from sliding, moving around, or falling off when force is being exerted by a user or when the canisters are being placed on an uneven surface.

2. The system of claim 1, wherein the plurality of canisters comprises variant sizes and shapes stacked into one.

3. The system of claim 1, wherein the base comprises of a fold up that fits into the canister's detachably attached side walls.

4. The system of claim 1, wherein when the canisters are stacked within each other and empty, the lids of each are positioned opposite each other, vertically, horizontally, or in any other position.

5. The system of claim 1, wherein the plurality of canisters comprises apertures for air passage at equal spacing all around, wherein the air passage is blocked by a magnetic or non-magnetic sheet.

6. The system of claim 1, wherein the hole is also formed in any of the following ways: cylindrical, isosceles trapezium at 60 to 80 degrees, rectangular, square, circular, or any combination of the above.

7. The system of claim 1, wherein a screw buried within the lid serves as the attachment mechanism.

8. The system of claim 1, wherein the hole being a mold is generated during the manufacturing process to produce a standard “upside-down cup”, each of the upside-down cups is then connected to the canister to cover the gap at the base of each of the canisters while still allowing enough space for the lid handle to fit inside.

9. The system of claim 8, wherein an intent of the upside-down cup and the hole is to be used as a cover to protect the lid handle from coming into contact with the vegetables or goods, as well as prevent fluid from leaking out through the gap.

10. The system of claim 1, wherein the predefined shape of the lid comprises a flat shape lid, a lid with edges all around, a lid with groove all around, and/or any foregoing combination.

11. The system of claim 1, wherein the lid comprises bamboo lids with a grove or an indent into the top surface of the lid.

12. The system of claim 1, wherein the base of each of the canisters and the “upside-down cup” is made from one piece of steelwork to reduce the amount of welding in joining the canister base and “upside-down cup together.

13. The system of claim 1, wherein solid items, liquid products, ultrafine products, or any mix thereof is stored in the plurality of canisters.

14. The system of claim 1, wherein the hole and lid handle coupling comprise any kind of magnetic property to provide more strength to the stack of the plurality of canisters.

15. The system of claim 1, wherein the lid comprises a two-step ergonomic design to fit into the top of the base for closure.

16. A plurality of stackable canisters used in kitchens for space-saving storage arrangements, the plurality of canisters are stacked on top of one another and fit inside storage spaces when empty, each of the plurality of stackable canisters comprises:
an ergonomic lid with a predefined shape for each of the stacked canisters that provides coverage and support for the next stackable canister, each of the ergonomic lids has a size dependent on the size of the base with side walls, each of the ergonomic lids features a screw that is entirely hidden and incorporated into the lid, as well as a lid handle that allows each canister's lid handle to fit on top;
the base with side walls, including a hole to allow for the lid handle attached to the lid of each of the canisters below, to fit inside the hole, when the hole and the lid handle are aligned, each of the canisters being placed flat on top of the ergonomic lid, the ergonomic lid handle serves as a stopper to prevent each of the canisters above from sliding, moving around, or falling off when force is being exerted by a user or when the canisters are being placed on an uneven surface.

17. The stackable canisters of claim 16, wherein the lid handle is cylindrical, isosceles trapezium from the top, but bent from the edges, circular, rectangular, or any combination of these shapes.

18. The stackable canisters of claim 16, wherein at least one of the plurality of canisters comprises dividers, recipe cards, or any combination.

19. A process for making a kitchen storage system with stackable canister, the process comprising:
stacking a plurality of canisters used in kitchens for space-saving storage arrangements, the plurality of canisters are stacked on top of one another and fit inside storage spaces;
providing coverage and support for the next stackable canister using a lid for each of the canisters;
embedding an attachment mechanism that is altogether hidden and embedded inside the lid and a lid handle, allowing each canister's lid handle to fit on top; and
connecting a base detachably to side walls to obtain a canister, the base including a hole to allow for the lid handle attached to the lid of each of the canisters below, to fit inside the hole, when the hole and the lid handle are aligned, each of the canisters being placed flat on top of the lid, the lid handle acts as a stopper to prevent each of the canisters above from sliding, moving around, or falling off when force is being exerted by a user or when the canisters are being placed on an uneven surface.

20. The process of claim 19, wherein the base is a raised platform that fits into the detachable side walls of the canister.
